(19) United States
(12) Patent Application Publication
(10) Pub. No.: US 2011/0286750 A1
(43) Pub. Date: Nov. 24, 2011

(54) Optimal Method for Visible Light Communications

(76) Inventors: Soo-Young Chang, Davis, CA (US); Sang-Yoon Chang, Davis, CA (US)

(21) Appl. No.: 13/108,943

(22) Filed: May 16, 2011

Related U.S. Application Data
(60) Provisional application No. 61/345,657, filed on May 18, 2010.

(51) Int. Cl. H04B 10/10

(52) U.S. Cl. 398/130

(57) ABSTRACT

As demand for wireless communications increases, it is becoming more important to efficiently use a frequency band. To support simultaneous multiple transmissions, a frequency band is divided into multiple channels or subbands. In this invention, a band division method for visible light communication (VLC) is invented with a goal of maximizing the communication efficiency of spectrum and fairness among channels. Reviewing the factors that should be considered when constructing channels in a visible light band, a new band division method using photo detection responsivity that yields the optimal and fair rate performance for the communication network is invented. Evaluation analysis shows the superiority of the invented scheme over currently existing band division method.

### TECHNICAL FIELD

The present invention relates generally to a method for visible light communications, and more particularly to a method for manipulating a visible light signal by dividing a visible light band into multiple subbands to deliver data information through visible light channels.

### BACKGROUND OF THE INVENTION

Visible light communication (VLC) is a communication method using visible lights. Some of the main goals achievable with VLC are as follows: ubiquity for communication where illumination is provided; point-to-point (PTP) communication or broadcast where illumination is not provided; complementary (or supplementary) communication where conventional RF (Radio Frequency) wireless communication is provided; and alternative communication where conventional RF wireless communication is not provided.

Major distinctions between VLC and radio communications are as follows. VLC has its unique communication channels and signal sources. Thus it has some distinctive properties from conventional radio communications. A couple of major distinctions between these two are listed as follows. With VLC, data delivery is performed by manipulating and measuring light, in terms of its perceived brightness or colors to human eyes or photo detection devices. The radiant power at each wavelength (or equivalently the inverse of a frequency) is weighted by a luminosity function (also known as visual sensitivity function) that models human brightness sensitivity. On the contrary, for radio communications, data delivery is performed by manipulating electromagnetic signals and detecting parameters of the received signals or measuring radiant energy in terms of absolute power. Another major distinction is that, for VLC, a light signal occupies a certain amount of frequency (or wavelength) band before it is manipulated for modulation for data delivery. On the contrary, for radio frequency communications, a carrier signal usually has a single frequency component which is modulated with data although eventually the transmitted signal has a certain amount of band after modulation.

In this invention, some general methods to process visible light signals—especially to divide frequency bands—are to be devised. Before we explain these methods, it should be mentioned that there are a lot of factors to be considered for VLC signal processing. Some of them are as follows:

### 1. Eye Sensitivity

To generate light of a color which is perceivable by human eyes, eye sensitivity should be considered. For human eyes, each wavelength has different sensitivity for each color. That is, human eyes have different sensitivity for each wavelength to perceive a specific color. Chromaticity function reflects human eyes' sensitivity for various wavelengths.

### 2. Spectral Distribution of Light Sources (or Light Emitting Devices)

Each light source (or light emitting device) has its own spectral distribution. This distribution determines its color that is recognizable by human eyes. To realize colors to be recognized by human eyes, these distributions should be considered.

### 3. Light Color Spaces

So far there are several light color spaces introduced to represent light colors. A light signal is represented as a point on a color space. That means, a point on a color space represents the color of a light signal while a color of light is represented not by only one point on a color space. Different points can represent the same color. To mix multiple light signals having different colors to generate a light signal having a target color, a set of color coordination coefficients can be calculated to define intensities of all available light signal components.

### 4. Responsivities of Photo Detectors

Each photo detection device has a different responsivity for a wavelength. Responsivity of a photo detection device reflects how it responds for each wavelength when it receives light signals. At the receiver, one possible way to compensate perceptual non-uniformity is post emphasis applied to the received (or detected) signals.

5. Colors and Comfortableness of Light from Light Emitting Devices after Modulation

Modulation may change colors of light although it is usually not intended with modulation. Any target color which is observed after modulation for communication should be able to be generated because it is to be recognized by human eyes. It means that a target color should not be changed in the process of modulation. To mix multiple colors to generate any target color perceivable by human eyes, a set of color coordination coefficients (or intensities of light sources) in a light color space should be calculated.

### 6. Illumination Efficiency and Communication Performance

Sometimes existing illumination systems can be used for light sources for VLC. For that case, communications should not degrade illumination efficiency, and illumination control such as dimming control should not affect communication performance. There should be no or minimum performance degradation due to dimming.

For some VLC communications, the given frequency band (or wavelength range or wavelength spectrum) is divided into subbands for multiple reasons. These reasons include modulation using multiple bands such as frequency shift keying and frequency division multiplexing or frequency division multiple access. In this invention, for this case of band division, some methods to divide the whole frequency band into some subbands more efficiently are devised.

### SUMMARY OF THE INVENTION

In this invention, a method for division of a visible light signal band using photo detection responsivity to have better performance is invented. To do this,

three factors necessary to devise frequency band division methods are identified,

an existing method which uses human eye sensitivity is reviewed,

a couple of metrics to evaluate these methods are identified,

additive noise is analyzed for evaluation of the methods, and

these two methods are evaluated using the metrics identified.

Through simulations for evaluation, it is shown that the invented method is superior to the existing method with respect to bit error rate performance for the whole band and communication fairness among subbands.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 shows spectral distributions for various color LEDs. Colored LEDs have narrower bands while white LEDs have broader bands;

FIG. 2 shows human eye sensitivity—luminosity function, the luminance response of the human eye cone photoreceptors. Human eyes are more sensitive to light components in the central part of visible light band;

FIG. 3 shows some examples of responsivity curves for various photo detection devices. In the visible light band, the responsivity increases approximately linearly with respect to wavelength;

FIG. 4 is a result of band division of the entire visible light band based on human eye response to wavelength (an example for seven subbands case);

FIG. 5 shows average responsivity of photo detectors which is calculated by averaging responsivity values of various types of photo detection devices from multiple vendors. One responsivity curve is also shown from a specific vendor;

FIG. 6 is a result of band division based on photo detector response to wavelength (or photo detection responsivity) for seven subbands case. Vertical solid lines divides the whole band into seven subbands for the new band division method invented based on photo detection responsivity;

FIG. 7 is one result of frequency band division using the new method invented for seven subband case;

FIG. 8 is for comparison of two band division methods while showing various LED spectral distributions. Dotted lines are for the existing band division method while solid lines shows the new band division invented; and

FIG. 9 is a graph for comparison of signal power values of subbands obtained from two band division methods. The new method invented here has an equal uniform received power for each subband while the existing method has uneven received powers for all subbands.

### DETAILED DESCRIPTION OF THE INVENTION

### 1. Introduction

Recently visible light communications (VLC), wireless communications operating in the visible light range, were introduced as an alternative way to be used for short range and medium range communications in some areas where conventional radio frequency (RF) communications are less efficient to deploy, e.g., in hospital environments, or where existing illumination systems can additionally serve as communication infrastructures for VLC.

Visible light signals have wavelengths that range from 380 nm to 780 nm. This frequency (or wavelength) band can be divided into multiple communication channels or subbands to support simultaneous multiple transmissions, e.g., wavelength division multiplexing (WDM). For example, for radio frequency communications, Federal Communications Commission (FCC) divides the frequency band into subbands with equal bandwidth. Due to the increasing demand for wireless communications, a frequency band must be divided into channels in a manner that maximizes the efficiency of the band. In this invention, the inventors consider light's unique characteristics in order to efficiently divide the visible light band.

Most light emitting devices including LEDs do not support saturated colors and may transmit light signals in multiple bands while a part of frequency band is intentionally eliminated for better communication performance, e.g., for the case of guard bands. For frequency division duplex (FDD) mode, adjacent bands may be impacted by spectral leakage from its own transmitter. To overcome this problem, the entire channel band is divided into multiple subbands to eliminate adjacent subbands for two-way duplexing. To implement these features, there can be a method that divides the frequency channel based on human eye sensitivity. However, this method is not optimal for communication performance because the light signals for communications are not detected by human eyes, but by photo detection devices such as photo diodes at receivers. Thus characteristics of photo detection devices should be considered for better communication performance. In this invention, the inventors use photo detection responsivity, a kind of sensitivity of devices to light intensity, to divide the visible light band. Using proportional fairness and channel capacity, the inventors also demonstrate the improvement in communication performance over the currently existing method of utilizing human eye sensitivity by evaluating the invented scheme.

Another motivation for the invented scheme is to ensure power-fairness across the channels (i.e., equal received power for all channels). In addition to offering equal expected performance for all channels, this fairness is very important in scenarios where wireless users have capability of accessing more than one channel, such as dynamic channel access using cognitive radio technology and frequency hopping to mitigate jamming and interference. Having a constant received power, regardless of which channel the user operates on, enables users to have the same transmission range and thus makes the link more robust to failure. In contrast, having varied received power levels for the subbands increases potential for the link to fail. For example, by switching to a channel that has lower received power, a transmission which has previously been reliably delivered may fail, because the receiver has fallen outside of the transmitter's transmission range, i.e., lower level of received signal-to-noise ratio (SNR) at the receiver. Therefore, in environments where wireless users do not use an entire single channel all the time, the scheme invented here improves the reliability of communication links.

### 2. Factors Considered for Band Division

Much like traditional communications, we must consider the factors that affect the performance when dividing the frequency band. In this invention, three characteristics of VLC signals are considered for band division: light source spectral distributions, human eye sensitivity, and responsivities of photo detection devices. As can be seen in this invention, there is a tradeoff for choosing one factor over another when dividing a frequency band. These three factors can be considered together to compromise the tradeoffs among these factors. However, in this invention, the inventors attempt to emphasize the importance of considering photo detection responsivities when dividing the visible light band to maximize communication performance. Up to now, utilization of photo detection responsivities for band division has not been investigated, unlike light source spectral distributions and human eye sensitivity.

### A. Light Source Spectral Distribution

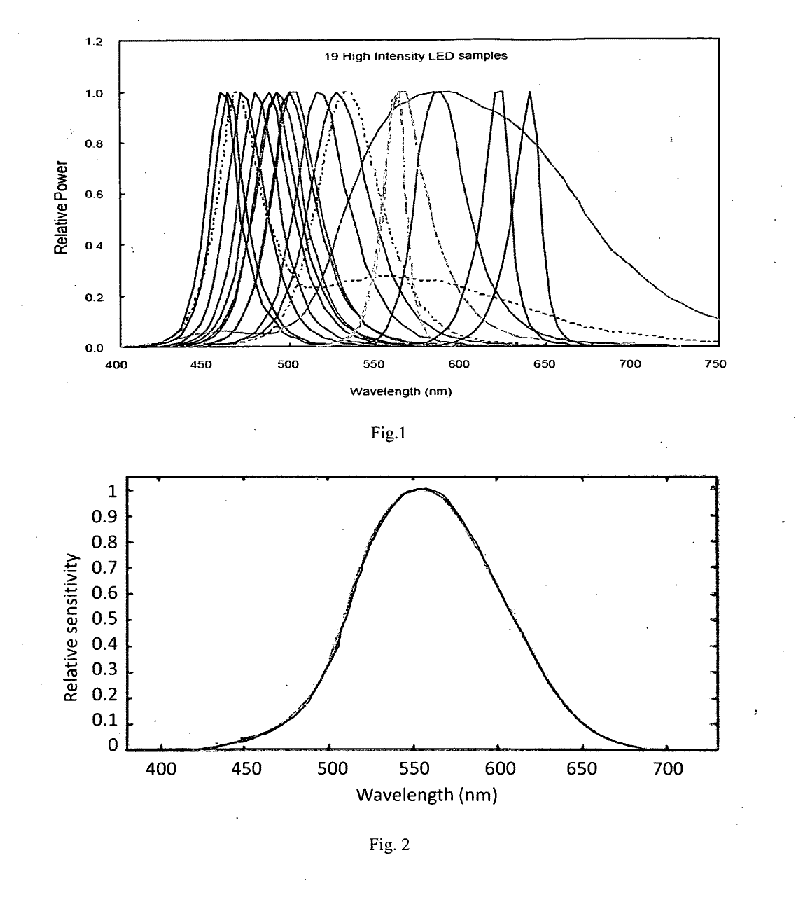

All types of light emitting devices (or light sources) are considered in this invention. Although other types of light sources can be considered for VLC, various types of light emitting diodes (LED) are major sources that transmit light with their own colors and spectral distributions as shown in FIG. 1. White LEDs tend to have broader distributions while colored LEDs have relatively narrower distributions. In this invention, we assume that light is transmitted with a flat radiated power in the entire visible light band and do not consider these partial spectral distributions when devising this invented scheme.

### B. Human Eye Sensitivity

VLC is unique from other communication systems in that its signal is discernible to human eyes. Since most of the applications for VLC lie in human-accessible environment, human eye sensitivity must be considered for safety and comfortness reasons.

The visible light signal is recognized by human eyes with a distinct non-uniform sensitivity for each wavelength. As shown in FIG. 2, the edge frequency components are less sensible than the central part of the band. Thus, given the same amount of transmit power for all wavelengths, human eyes can recognize a greater brightness in one wavelength than another.

### C. Photo Detector Responsivity

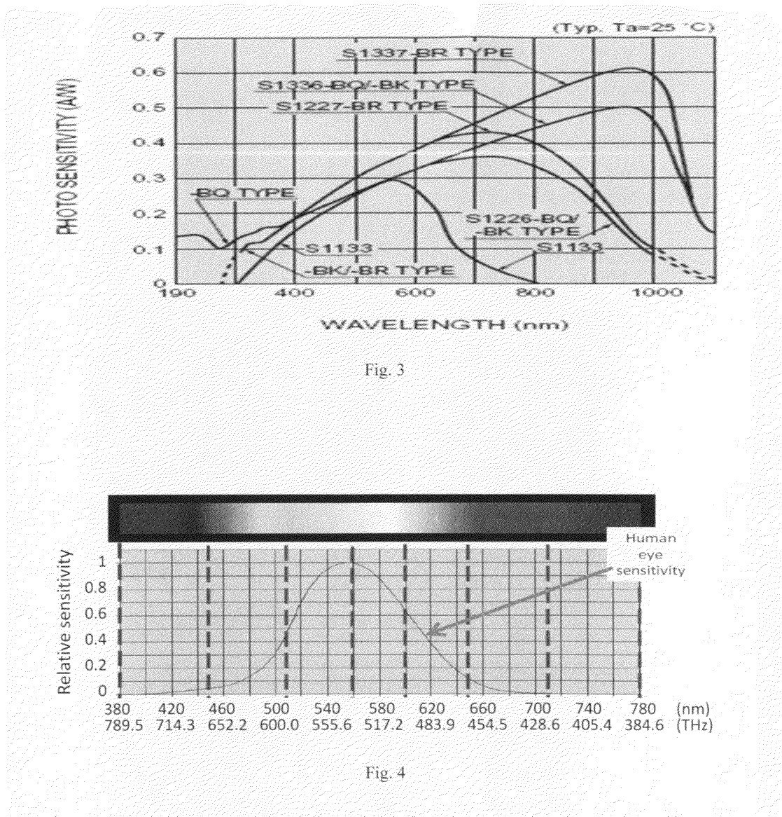

Similar to human eye sensitivity, responsivity of a photo detector measures how sensitive the device is to signals of a certain frequency. It corresponds to the amount of received signal power given a constant level of transmitted power across the visible light frequency range. As shown in FIG. 3, generally, the edge band can be recognized with less power while the central part of the band has approximately linear responsivity with respect to wavelength.

### 3. Existing Frequency Division Method

In this invention, the inventors introduce the currently existing frequency band division method that only uses human eye sensitivity to divide the frequency band to compare with the newly invented method. The motivation of such existing method is to make human eyes recognize uniform brightness (or light power) for all colors (or subbands). This recognition of uniform brightness can be achieved through illumination prior to applying the light for VLC if the light signal of communication is transmitted through illumination systems, since data communication applied does not affect any change of colors or brightness.

By integrating the curve corresponding to human eye sensitivity in FIG. 2, the light power in each subband can be calculated. The whole wavelength band (or frequency band) is divided into a fixed number of subbands so that the light power recognized by human eyes for each subband given uniform transmit power and uniform channel gain is equal. Since human eyes have lower sensitivities at the edge of visible light band and higher sensitivity at the center of visible light band, a signal is transmitted with a wider bandwidth by light emitting devices for an edge subband while transmitted with a narrower bandwidth by light emitting devices for a center subband to be recognized with equal light power for all subbands to human eyes. For example, FIG. 4 shows the result of dividing the whole visible light band when it is divided into seven subbands.

### 4. New Band Division Method Invented

Utilizing the photo detection responsivity to divide the visible light band into multiple subbands (or channels), the inventors devised a method that maximizes the rate performance and ensure fairness by collecting equal electrical power at receivers for each subband. As explained in the section below, the inventors utilize a legitimate performance metric in energy per bit to noise density ratio (E_{b}/Nₒ). Goal for the invention is to yield equal bit error rates (BERs) at a receiver for all subbands, which is equivalent to making all subbands yield the same E_{b}/Nₒ. In addition, by allowing a receiver to collect equal power for each subband from the received signal, i.e., by making received power stay the same regardless of the choice of a subband, the overall network performance can be maximized. Manipulating responsivities of photo detection devices, the inventors devised a method that divides the entire band with wider bandwidths for lower-responsivity subbands and narrower for higher-responsivity subbands.

### Performance Metric and Optimality Definition

Assuming additive white Gaussian noise at a receiver, for most modulation schemes,

BER∝Q(a(E_{b}/Nₒ)^{c}) (1)

where Q is the Q-function of a normal distribution and a and c are arbitrary constants corresponding to the modulation scheme applied. Therefore, BER is a monotonically decreasing function with respect to E_{b}/Nₒ. For the metric for this invention, we use the E_{b}/Nₒ for the performance reliability of the communication system.

Another motivation to use E_{b}/Nₒ as a performance metric is that it directly affects the rate. In this invention, we consider the maximum achievable spectral efficiency of the system (derived from Shannon's equation by getting rid of its bandwidth dependence and replacing signal to noise ratio (SNR) with E_{b}/Nₒ):

$${C}_{i} = {log}_{2} ( 1 + {( \frac{{E}_{b}}{{N}_{o}} )}_{i} ) , ∀ i \qquad ( 2 )$$

where Cᵢ indicate the rate spectral efficiency of the ith subband (or user of the network). This expression implies that the rate is convex and increases monotonically with respect to E_{b}/Nₒ.

We wish to optimize the performance, the rate spectral efficiency expression in Equation (2), of the overall network as opposed to that of an individual user. Ensuring a proportional fairness among subbands (or users), the utility function is:

C_{network}=Σᵢ log(Cᵢ). (3)

Using Equation (3) as the utility function, the invented scheme using photo detection responsivities to divide the frequency band yields the optimal performance by making all users to have even E_{b}/Nₒ. The intuition behind this argument is Jensen's inequality. To maximize the utility function (or to minimize the negative of the utility function), the inventors use the fact that it is concave (or convex) and that the expected SNR from accessing a channel corresponds to the maximum (minimum) rate. Therefore, we wish to have the band divided so that all the channels yield the same E_{b}/Nₒ performance.

To make E_{b}/Nₒ of all subbands equal, a method is invented where received signal power for a subband can be obtained by integrating responsivity function for an entire subband under an assumption that the incoming signal at the receiver input has uniform power density throughout the whole band. This will be discussed in detail in one of the following sections below.

### Noise Analysis

E_{b}/Nₒ and received power are related to noise power spectral density. The total noise power spectral density, Nₒ, for a subband consists of two types of noise power densities: for interior noise, Nₒᵢ which is assumed as white noise and for exterior noise, Nₒₒ, which is a sum of noise densities from incandescent light, N_{oc}, fluorescent light, N_{of}, sun light, Nₒₛ, and other LED light, Nₒₗ if these noises are uncorrelated as briefly explained in Appendix. The total noise power spectral density, Nₒ, is expressed as

Nₒ=Nₒᵢ+Nₒₒ. (4)

Unlike exterior noise, interior noise is not affected by responsivities: More exterior noise is detected for higher responsivities while interior noise is fixed and caused by the receiver circuit. In this invention, for simplicity, the inventor only considers interior noise for analyses and assumes that it is white, i.e., constant for all frequencies.

### Use of Responsivity of Photo Detectors

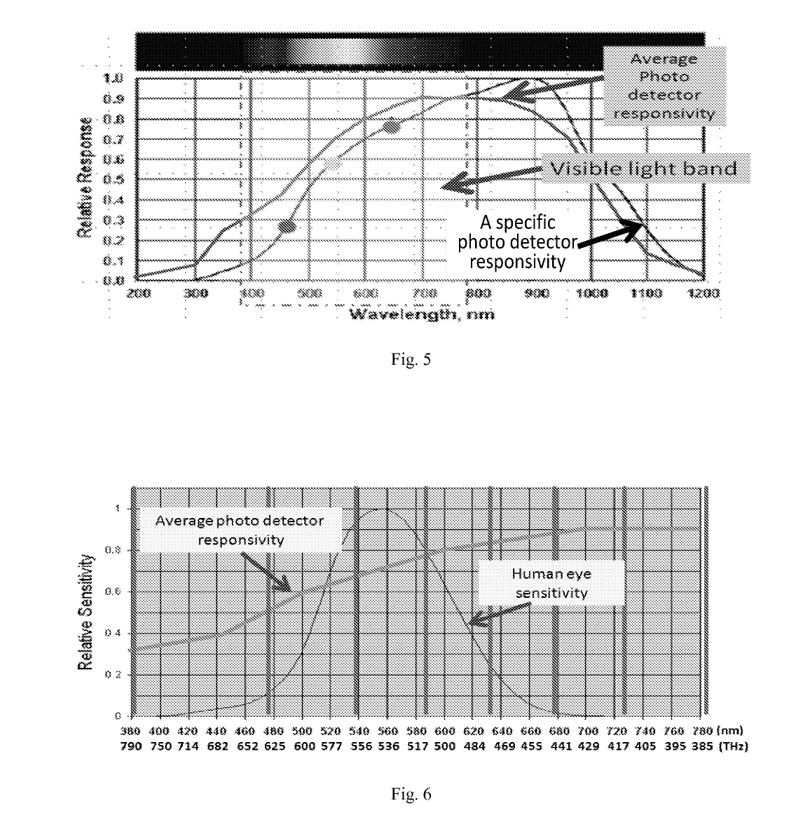

Various photo detection devices which are available in the market have their own responsivity characteristics. Hence it is not easy to get a responsivity measurement which represents all devices to be applied for band division. In this invention, responsivity curves for various typical types of photo detection devices are collected and averaged to obtain a responsivity value for each wavelength. A curve from these values is plotted in FIG. 5. This curve can be used for responsivity characteristics which can be accepted for the method devised in this invention. As seen in this figure, responsivity values monotonically increase as wavelength increases in the visible light band.

### New Band Division Method Using Responsivities of Photo Detectors

In order to make a receiver have evenly distributed received power for all subbands, responsivities of photo detection devices, rather than human eye sensitivity, should be utilized to divide the whole frequency band, because visible light signals are detected at receivers to extract communication information by photo detection devices, not by human eyes. Using these responsivity values, the whole band can be divided into subbands to achieve equal received power when the transmitted light signal has uniform spectral distribution such that

∫ₛ₁R²(f)df=∫ₛ₂R²(f)df= . . . =constant (5)

where sᵢ is frequency range of the ith subband and R(f) is the average responsivity of photo detection devices as a function of frequency, f. This method improves reliability performance in a multi-channel environment (e.g., providing a basis to increase spectral efficiency by allowing dynamic spectrum access) since it enables a VLC transmitter to maintain a constant transmission range and make the communication link more robust.

Thus by using the responsivity curve shown in FIG. 5, the whole band can be divided into subbands so that the lower wavelength band has larger frequency bandwidth and vice versa. The new band division result is shown in FIG. 6 with solid lines as an example for seven subbands case.

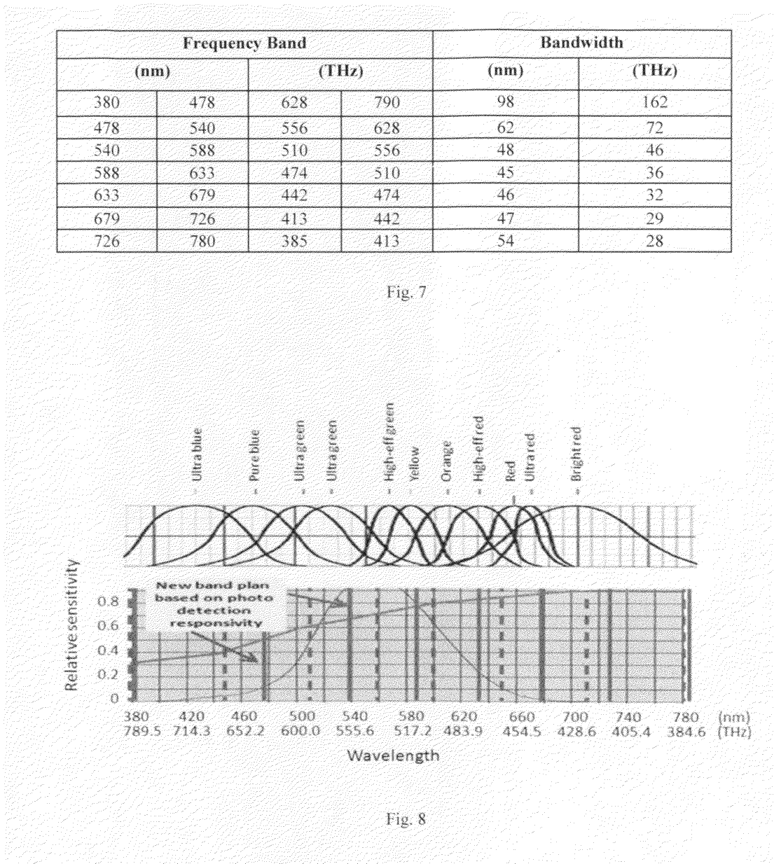

FIG. 7 lists all subbands information including wavelength and frequency ranges and their corresponding bandwidths from the newly invented frequency division method for a seven subband case. Furthermore, FIG. 8 shows comparison of frequency division results for the existing method and the newly invented method and how most of subbands can be matched to the corresponding LEDs. In this figure, dotted lines illustrate division from the existing method while solid lines from the new method proposed in this invention.

### 5. Evaluation and Analysis

The invented scheme focuses on maximizing the communication performance and ensuring fairness among subbands. The inventors demonstrate via simulations how the invented scheme yields better communication performance than the previous method of using human eye sensitivity to divide the visible light band.

### Evaluation Results

The invented method and the method using human eye sensitivity yield different frequency division results as shown in FIG. 8 because they use different characteristics of visible light. Although various aspects may be considered for performance evaluation, the inventors focus on the rate spectral efficiency and E_{b}/Nₒ performance in our analysis and evaluation.

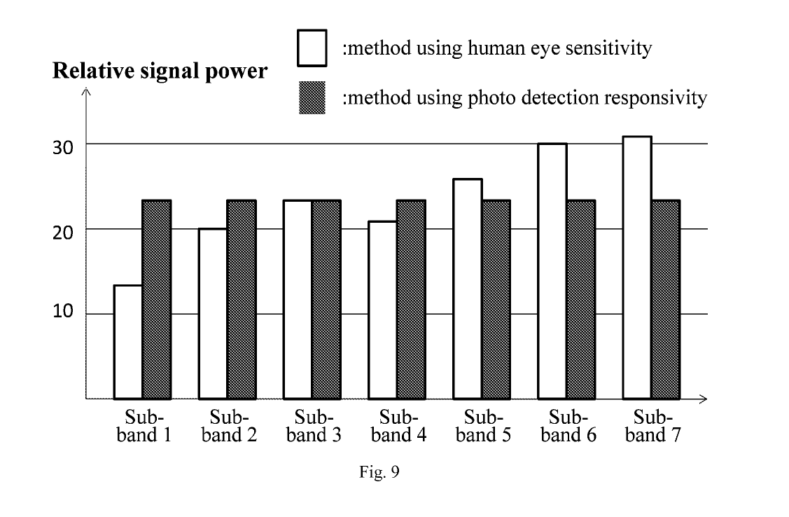

As introduced in one of the above sections, E_{b}/Nₒ is a metric to evaluate and compare these methods. The simulated E_{b}/Nₒ comparison result is shown in FIG. 9 for a fixed rate. As expected, the new method invented here has an equal E_{b}/Nₒ value for all subbands while the existing method has different E_{b}/Nₒ values which fails to achieve the maximum communication performance of the whole network and has a significantly different communication capacity for each subband. Using Equation (3), we can observe that the invented scheme results in approximately 0.05 dB rate spectral efficiency gain, or more than 1.1% rate spectral efficiency gain, over the band division using human eye sensitivity for E_{b}/Nₒ=24 as shown in FIG. 9 as an example result. We observe a performance gain by merely changing the metric that will be used to divide the band from the sensitivity of a third party (human) to the communication receiver device's responsivity. This performance gain becomes more considerable especially in a high-rate communication where users consume more bandwidth. An example using on-off keying (OOK) modulation is illustrated in Appendix which also shows performance gain with the new method.

The inventers also observe a much fairer performance for the invented scheme. While the E_{b}/Nₒ performance varies with respect to the deployed subband (as much as 3.43 dB, or more than 2.2 times, difference) using the currently existing method, the invented method yields equal performance for all the subbands. Thus the new method ensures fairness among channels (or subbands).

### 6. Conclusions

The inventors introduce a novel metric to be used for visible light band division, namely the photo detection responsivity. By using the photo detection responsivity of the receiver device rather than the currently existing metric of the third party (not participating in communication), i.e., human's eye sensitivity, we achieve higher rate performance and more reliable communication, i.e., lower error rates. The invented scheme divides the band so that all subbands have equal E_{b}/Nₒ and thus results in fairness for all users. Furthermore, simulation shows the superiority of the invented scheme over the band division method using human eye sensitivity.

### APPENDIX

### Analysis Using OOK-NRZ

As another evaluation, consider simple on-off keying (OOK) modulation with non-return-to-zero (NRZ). Then signal for each binary symbol is represented as

x₁(t)=A+n(t) for a “1”

x₀(t)=n(t) for a “0”. (6)

Knowing that the noise has a bilateral spectral density, N₀/2, then the total noise is

n(t)=nᵢ(t)+nₒ(t). (7)

These noise components have normal distribution with

$${n}_{i} ( t ) : N ( 0 , \frac{{N}_{oi}}{2} ) \\ {n}_{o} ( t ) : N ( 0 , η \frac{{N}_{oo}}{2} ) \qquad ( 8 )$$

where N(μ.σ²) is a normal distribution with mean of μ and standard deviation of σ² and η is the responsivity factor. Assuming Nₒ, Nₒᵢ, and Nₒₒ be fixed if nᵢ(t) and nₒ(t) are white, then

$$\frac{{N}_{o}}{2} = \frac{{N}_{oi}}{2} + η \frac{{η}_{oo}}{2} + 2 cov ( {n}_{i} , {n}_{o} ) . \qquad ( 9 )$$

Since nᵢ and nₒ are uncorrelated, then

$${x}_{1} ( t ) : N ( A , \frac{{N}_{o}}{2} ) = N ( A , \frac{{N}_{oi}}{2} + η \frac{{N}_{oo}}{2} ) \\ {x}_{0} ( t ) : N ( 0 , \frac{{N}_{o}}{2} ) = N ( 0 , \frac{{N}_{oi}}{2} + η \frac{{N}_{oo}}{2} ) . \qquad ( 10 )$$

Then

BER=p((0|1)p₁+p((1|0)p₀. (11)

Since the average energy of the signal, E, with a period of one symbol, T,

$$E = \frac{{A}^{2} T}{2} , \qquad ( 12 )$$

then

$$B E R = \frac{1}{2} erfc ( \sqrt{\frac{E}{2 {N}_{o}}} ) . \qquad ( 13 )$$

This equation coincides with Equation (1) for a specific modulation.

Two ways were considered to evaluate these methods with the following values: Nₒᵢ=Nₒₒ=½Nₒ, and E_{b}/Nₒ=24.

The first one is to get the rate for the case of a fixed BER. From Equation (13), E is proportional to signal power and T. The rate is inversely proportional to T. To have a fixed BER, the rate is proportional to signal power for a fixed value of Nₒ. η values from FIG. 5 and signal power values from FIG. 9 can be used. For this specific case, the invented scheme results in approximately 0.4% rate spectral efficiency gain (or equivalently 0.02 dB gain) over the scheme using human eye sensitivity.

The second one is that using E_{b}/Nₒ for each subband, BER corresponding to this E_{b}/Nₒ can be obtained from a plot of BER versus E_{b}/Nₒ for amplitude modulation. For a fixed BER, rates can be aggregated for all subbands throughout the whole band. This method shows almost the same results as in the first one.

What is claimed is:

1. A visible light communication method in a visible light communication system comprising a transmission apparatus having a light emitting device or light emitting devices and a reception apparatus having a photo detection device or photo detection devices, the method comprising dividing a whole band into multiple subbands in a way to achieve optimal communication performance.

2. The visible light communication method in a visible light communication system of claim 1, further comprising using responsivity characteristics of photo detection devices or receiver devices.

3. The visible light communication method in a visible light communication system of claim 1, further comprising having all subbands have equal received power.

4. The visible light communication method in a visible light communication system of claim 1, further comprising using the communication efficiency of spectrum and fairness among channels for two factors for communication performance evaluation.

5. The visible light communication method in a visible light communication system of claim 1, further comprising maximizing the overall communication efficiency of spectrum.

6. The visible light communication method in a visible light communication system of claim 1, further comprising achieving the fairness among channels.

7. The visible light communication method in a visible light communication system of claim 1, further comprising using bit error rate (BER) as a metric to evaluate the communication efficiency of spectrum and fairness among channels.

8. The visible light communication method in a visible light communication system of claim 1, further comprising using E_{b}/Nₒ as a metric to evaluate the communication efficiency of spectrum and fairness among channels.

9. The visible light communication method in a visible light communication system of claim 1, further comprising using E_{b}/Nₒ to have the band divided into subbands so that all the subbands yield equal E_{b}/Nₒ performance.

10. The visible light communication method in a visible light communication system of claim 1, further comprising having subbands for a whole band from 380 nm to 780 nm into seven subbands, having 380-478, 478-540, 540-588, 588-633, 633-679, 679-726, and 726-780 nm.

11. The visible light communication method in a visible light communication system of claim 3, further comprising calculating a received power using responsivity characteristics of photo detection devices or receiver devices.

12. The visible light communication method in a visible light communication system of claim 3, further comprising calculating the received signal power for a subband by integrating responsivity function for an entire subband.
